(19) United States
(12) Patent Application Publication
(10) Pub. No.: US 2026/0197834 A1
(43) Pub. Date: Jul. 9, 2026

(54) DEVICE AND METHOD OF COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 19/129,459

(22) PCT Filed: Dec. 23, 2022
(86) PCT No.: PCT/CN2022/141267

§ 371 Date: May 13, 2025

(51) Int. Cl. H04W 72/23; H04W 74/0833

(52) U.S. Cl. CPC H04W 72/23; H04W 74/0833

(57) ABSTRACT

Embodiments of the present disclosure relate to devices and methods of communication. In one aspect, a terminal device receives, from a serving cell, DCI triggering an RA procedure on a candidate cell in a set of candidate cells allowing LTM, and transmits, to the candidate cell, a preamble for the RA procedure. The terminal device performs a PDCCH monitoring on at least one of the serving cell or the candidate cell, and receives an RAR from the at least one of the serving cell or the candidate cell. In this way, an RA procedure is achieved for a candidate cell for LTM.

### TECHNICAL FIELD

Embodiments of the present disclosure generally relate to the field of telecommunication, and in particular, to devices and methods of communication for a random access (RA) procedure.

### BACKGROUND

When user equipment (UE) moves from a coverage area of one cell to that of another cell, a change or addition or release of a serving cell may need to be performed. Currently, it has been proposed to trigger the change or addition or release of the serving cell by a lower-layer signaling such as layer 1 (L1)/layer 2 (L2) signaling, which is also referred to as L1/L2 triggered mobility (LTM). In this way, latency, overhead and interruption time may be reduced. However, an RA procedure for timing advance (TA) acquisition for LTM is still unclear and needs to be further developed.

### SUMMARY

In general, embodiments of the present disclosure provide methods, devices and computer storage media of communication for an RA procedure.

In a first aspect, there is provided a terminal device. The terminal device comprises a processor. The processor is configured to cause the terminal device to: receive, from a serving cell, downlink control information triggering a random access procedure on a candidate cell in a set of candidate cells allowing layer 1 or layer 2 triggered mobility; transmit, to the candidate cell, a preamble for the random access procedure; perform a physical downlink control channel monitoring on at least one of the serving cell or the candidate cell; and receive a random access response from the at least one of the serving cell or the candidate cell.

In a second aspect, there is provided a terminal device. The terminal device comprises a processor. The processor is configured to cause the terminal device to: receive, from a serving cell, downlink control information triggering a random access procedure on a candidate cell in a set of candidate cells allowing layer 1 or layer 2 triggered mobility, the downlink control information comprising a value of a power ramping counter for a preamble; determine received target power for the preamble based on the value of the power ramping counter; and transmit, to the candidate cell, the preamble for the random access procedure based on the received target power.

In a third aspect, there is provided a terminal device. The terminal device comprises a processor. The processor is configured to cause the terminal device to: receive, from a serving cell, first downlink control information triggering a random access procedure on a candidate cell in a set of candidate cells allowing layer 1 or layer 2 triggered mobility; transmit, to the candidate cell, a preamble for the random access procedure; and receive, from the serving cell, second downlink control information indicating whether the random access procedure is successfully completed.

In a fourth aspect, there is provided a method of communication. The method comprises: receiving, at a terminal device and from a serving cell, downlink control information triggering a random access procedure on a candidate cell in a set of candidate cells allowing layer 1 or layer 2 triggered mobility; transmitting, to the candidate cell, a preamble for the random access procedure; performing a physical downlink control channel monitoring on at least one of the serving cell or the candidate cell; and receiving a random access response from the at least one of the serving cell or the candidate cell.

In a fifth aspect, there is provided a method of communication. The method comprises: receiving, at a terminal device and from a serving cell, downlink control information triggering a random access procedure on a candidate cell in a set of candidate cells allowing layer 1 or layer 2 triggered mobility, the downlink control information comprising a value of a power ramping counter for a preamble; determining received target power for the preamble based on the value of the power ramping counter; and transmitting, to the candidate cell, the preamble for the random access procedure based on the received target power.

In a sixth aspect, there is provided a method of communication. The method comprises: receiving, at a terminal device and from a serving cell, first downlink control information triggering a random access procedure on a candidate cell in a set of candidate cells allowing layer 1 or layer 2 triggered mobility; transmitting, to the candidate cell, a preamble for the random access procedure; and receiving, from the serving cell, second downlink control information indicating whether the random access procedure is successfully completed.

In a seventh aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a central unit (CU)/distributed unit (DU) architecture in which some embodiments of the present disclosure can be implemented;

FIG. 1E illustrates a schematic diagram illustrating a process of LTM in which some embodiments of the present disclosure can be implemented;

FIG. 2 illustrates a schematic diagram illustrating a process of communication in an RA procedure for LTM according to embodiments of the present disclosure;

FIG. 3 illustrates a schematic diagram illustrating another process of communication in an RA procedure for LTM according to embodiments of the present disclosure;

FIG. 4 illustrates a schematic diagram illustrating still another process of communication in an RA procedure for LTM according to embodiments of the present disclosure;

FIG. 5 illustrates an example method of communication implemented at a terminal device in accordance with some embodiments of the present disclosure;

FIG. 6 illustrates another example method of communication implemented at a terminal device in accordance with some embodiments of the present disclosure;

FIG. 7 illustrates still another example method of communication implemented at a terminal device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell switch” may be interchangeably used with “reconfiguration with sync for secondary cell group (SCG) or master cell group (MCG)” or “a cell change”. The term “PSCell” refers to a SpCell of a SCG the term “PCell” refers to a SpCell of a MCG, and the term “SpCell” refers to a primary cell of a SCG or MCG The term “SCell” refers to a secondary cell. The term “lower-layer signaling” may be interchangeably used with “L1/L2 signaling”. The term “RRC reconfiguration” may be interchangeably used with “RRC reconfiguration message”.

To reduce interruption time for LTM, it is agreed that an RA procedure may be performed for TA acquisition of candidate cell(s) before a cell switch command is received. Conventionally, an RA procedure is always performed on a serving cell of UE. In this case, the conventional RA procedure is no longer suitable for TA acquisition of a candidate cell which is not the serving cell of the UE.

In view of this, embodiments of the present disclosure provide solutions of communication so as to overcome the above issue and other potential issues. In one aspect, a terminal device receives, from a serving cell, downlink control information (DCI) triggering an RA procedure on a candidate cell in a set of candidate cells allowing LTM. Upon reception of the DCI, the terminal device transmits, to the candidate cell, a preamble for the RA procedure, and performs a physical downlink control channel (PDCCH) monitoring on at least one of the serving cell or the candidate cell. The terminal device receives a random access response (RAR) from the at least one of the serving cell or the candidate cell. In this way, RAR reception for PDCCH ordered RA for LTM candidate cell may be defined.

In another aspect, a terminal device receives, from a serving cell, DCI triggering an RA procedure on a candidate cell in a set of candidate cells allowing LTM, the DCI comprising a value of a power ramping counter for a preamble. The terminal device determines received target power for the preamble based on the value of the power ramping counter, and transmits, to the candidate cell, the preamble for the RA procedure based on the received target power. In this way, a preamble transmission for PDCCH ordered RA for LTM candidate cell may be properly achieved without RAR.

In still another aspect, a terminal device receives, from a serving cell, first DCI triggering an RA procedure on a candidate cell in a set of candidate cells allowing LTM. The terminal device transmits, to the candidate cell, a preamble for the RA procedure, and receives, from the serving cell, second DCI indicating whether the RA procedure is successfully completed. In this way, an RA procedure for PDCCH ordered RA for LTM candidate cell may also be defined.

Principles and implementations of the present disclosure will be described in detail below with reference to the figures.

### Example of Communication Network

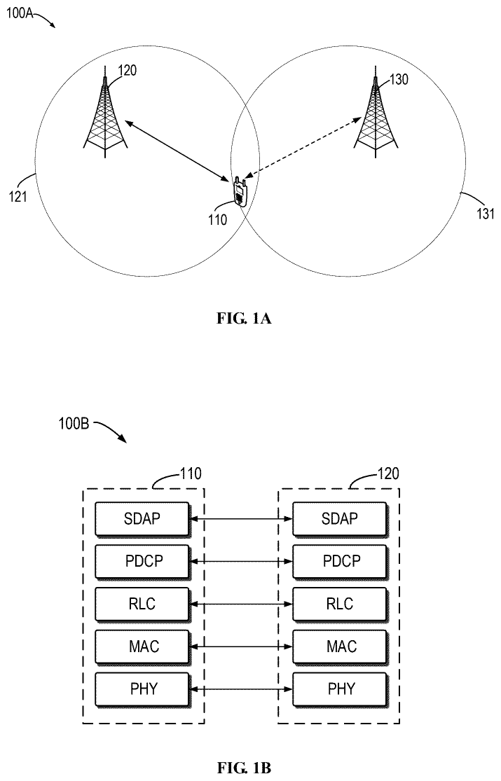

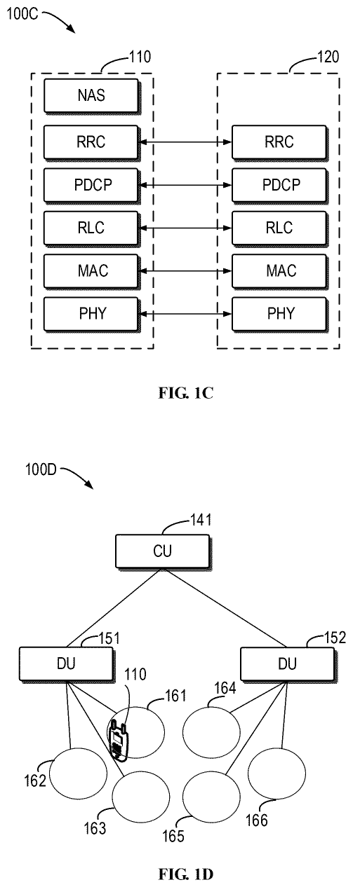

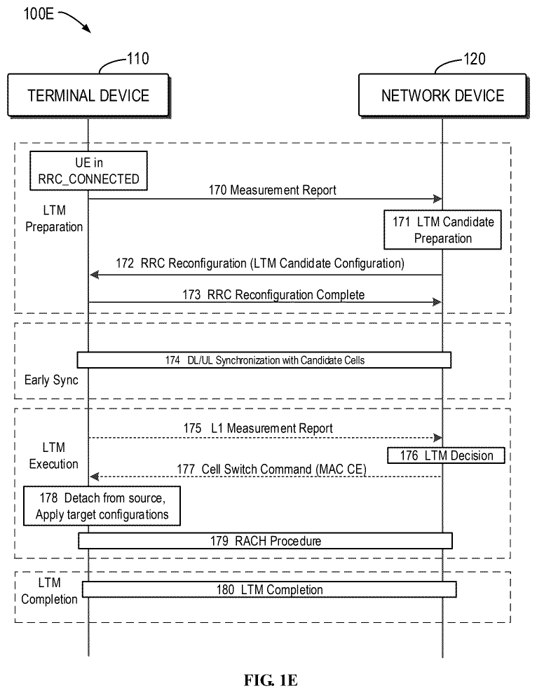

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a network device 120 and a network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 or 130 is referred to as uplink (UL) communication, while communication in a reverse direction from the network device 120 or 130 towards the terminal device 110 is referred to as downlink (DL) communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

In some embodiments, the network devices 120 and 130 may be different network devices. In some embodiments, the network devices 120 and 130 may be the same network device.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a medium access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture in which some embodiments of the present disclosure can be implemented. The CU/DU architecture may be established at a network device.

In the context of the present disclosure, a CU (also referred to as a gNB-CU herein) is a logic node hosting RRC, SDAP and PDCP protocols of a gNB or RRC and PDCP protocols of an en-gNB that controls operation of one or more DUs (also referred to as gNB-DUs herein). The gNB-CU terminates a F1 interface connected with the gNB-DU. A DU is a logical node hosting RLC, MAC and PHY layers of the gNB or en-gNB, and its operation is partly controlled by gNB-CU. One gNB-DU supports one or multiple cells. One cell is supported by only one gNB-DU. The gNB-DU terminates a F1 interface connected with the gNB-CU.

As shown in FIG. 1D, CU 141 is shown. It is to be understood that more CUs may be comprised. The CU 141 may communicate with multiple DUs. Here, two DUs 151 and 152 are shown for illustration. It is to be understood that more DUs may also be provided for implementation of embodiments of the present disclosure. Although not shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may provide cells 161, 162 and 163. DU 152 may provide cells 164, 165 and 166. It is to be understood that this is merely an example, and more or less cells are also feasible. The terminal device 110 may communicate with any of these cells.

In some embodiments, the terminal device 110 may switch from one cell to another cell under control of the same CU and same DU. For example, the terminal device 110 may be handed over from one cell 161 to another cell 162. This is called as an intra-CU intra-DU serving cell switch. In some embodiments, the terminal device 110 may switch from one cell to another cell under control of the same CU and different DUs. For example, the terminal device 110 may be handed over from one cell 161 to another cell 164. In this case, a cell switch from one cell of DU 151 to another cell of DU 152 will occur. This is called as an intra-CU inter-DU serving cell switch. In another example, the terminal device 110 may be handed over from a cell of one DU to a cell of another DU under control of different CUs. In this case, a handover from a CU to another CU will occur. This is called as an inter-CU handover.

The network device 120 and the network device 130 may correspond to one or two DUs under the same CU. In some embodiments, a CU and a DU may be implemented in separate devices. In some embodiments, a CU and a DU may be implemented in the same device. In some embodiments, different DUs may be implemented in separate devices.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 131. This is called as a handover. In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 131. This is called as a PScell change.

In some scenarios, the network device 120 may receive L1 measurement reports from the terminal device 110. Based on the L1 measurement reports, the network device 120 may change a serving cell of the terminal device 110 through a MAC CE. This procedure is called as LTM. The network device 120 may prepare one or multiple candidate cells and provides the candidate cell configurations to the terminal device 110 through a RRC message. Then LTM cell switch is triggered by selecting one of the candidate cell configurations as target configuration for LTM by the network device 120.

FIG. 1E illustrates a schematic diagram illustrating a process 100E of LTM in which some embodiments of the present disclosure can be implemented. For the purpose of discussion, the process 100E will be described with reference to FIG. 1A. The process 100E may involve the terminal device 110 and the network device 120 as illustrated in FIG. 1A. The network device 120 may be a MN or SN serving the terminal device 110. In this example, the network device 120 provides a serving cell for the terminal device 110. The network device 130 providing one or more candidate cells for the terminal device 110 is the same network device as network device 120.

As shown in FIG. 1E, at a LTM preparation stage, the terminal device 110 may send 170 a Measurement Report message to the network device 120. The network device 120 may decide 171 to use LTM and initiates LTM candidate preparation. The network device 120 may transmit 172 an RRCReconfiguration message to the terminal device 110 comprising the configuration of one or multiple LTM candidate target cells. The terminal device 110 may store the configuration of LTM candidate target cell(s) and transmit 173 a RRC Reconfiguration Complete message to the network device 120.

At an early synchronization (i.e., early sync) stage, the terminal device 110 may perform 174 DL synchronization and TA acquisition with candidate target cell(s) before receiving the LTM cell switch command.

At a LTM execution stage, the terminal device 110 may perform L1 measurements on the configured LTM candidate target cell(s), and transmits 175 lower-layer measurement reports to the network device 120. The network device 120 may decide 176 to execute LTM cell switch to a target cell, and transmits 177 a MAC CE triggering LTM cell switch by including the candidate configuration index of the target cell. The terminal device 110 may switch 178 to the configuration of the LTM candidate target cell. The terminal device 110 may perform 179 a random access procedure towards the target cell, if TA is not available. The terminal device 110 indicates 180 successful completion of the LTM cell switch towards target cell.

At a LTM completion stage, the terminal device 110 may indicate 180 successful completion of the LTM cell switch towards target cell.

It can be seen that an RA procedure may be performed for TA acquisition of a candidate cell before a cell switch command is received. In this way, interruption time for LTM may be reduced. However, a conventional RA procedure is always performed on a serving cell of UE and thus is no longer suitable for TA acquisition of a candidate cell.

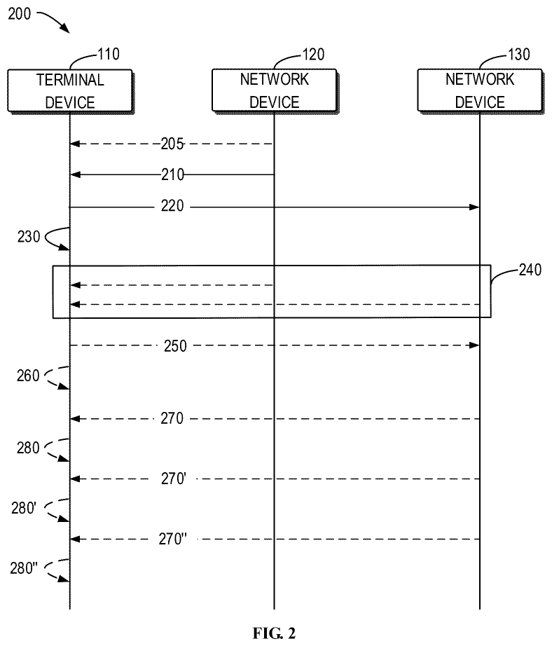

Embodiments of the present disclosure provide a solution of communication for RA to a candidate cell. Its detail will be described with reference to FIGS. 2 to 4.

### Example Implementation of RA to Candidate Cell

FIG. 2 illustrates a schematic diagram illustrating a process 200 of communication in an RA procedure for LTM according to embodiments of the present disclosure. For the purpose of discussion, the process 200 will be described with reference to FIG. 1A. The process 200 may involve the terminal device 110 and the network device 120 as illustrated in FIG. 1A. In this example, the network device 120 provides a serving cell (e.g., the cell 121) for the terminal device 110, and the network device 130 provides a candidate cell (e.g., the cell 131) for the terminal device 110.

As shown in FIG. 2, the network device 120 may transmit 205, to the terminal device 110, a RRC reconfiguration message comprising a set of RRC configurations corresponding to a set of candidate cells allowing LTM.

The terminal device 110 may receive 210, from the serving cell (e.g. cell 121) of the network device 120, DCI/PDCCH signaling triggering an RA procedure on a candidate cell (e.g., the cell 131) in the set of candidate cells. The serving cell may be SpCell, PCell or PSCell of the network device 120. This RA procedure is also referred to as a PDCCH ordered RA procedure. Upon reception of the DCI, the terminal device 110 may transmit 220, to the candidate cell of network device 130, a preamble for the RA procedure.

The terminal device 110 may perform 230 a PDCCH monitoring on at least one of the serving cell or the candidate cell. In some embodiments, upon transmission of the preamble, the terminal device 110 may start a time window for RAR, and monitor the PDCCH of at least one of serving cell or candidate cell for RAR within the time window.

Then the terminal device 110 may receive 240 an RAR from the at least one of the serving cell or the candidate cell. For illustration, some example embodiments for RAR reception will be described below with reference to Embodiments 1 to 4.

### Embodiment 1

In some embodiments, the RAR may comprise a TA command for the candidate cell.

In some embodiments where the RAR is received from the serving cell, the terminal device 110 may transmit the preamble on an RA resource (for example, a preamble index or RA occasion) dedicated for the candidate cell. In some embodiments where the RAR is received from the serving cell, the network device 120 may configure a search space dedicated for TA acquisition of the candidate cells, and the terminal device 110 may perform the PDCCH monitoring on the configured search space. In some embodiments where the RAR is received from the serving cell, the RAR may comprise information of the candidate cell. For example, the RAR may comprise an ID of the candidate cell.

For illustration, an example procedure may be described as below.
UE receives PDCCH signaling/DCI triggering an RA procedure (i.e., PDCCH ordered RA) on the candidate cell of LTM from the serving cell (e.g. SpCell, PCell, PSCell), and transmits preamble to the candidate cell. Once the Random Access Response is transmitted, UE shall
start the ra-ResponseWindow, and monitor the PDCCH of at least one of candidate cell or serving cell for Random Access Response(s) identified by the RA-RNTI while the ra-ResponseWindow is running; and
receive Random Access Response from at least one of candidate cell or serving cell;
in case the PDCCH monitoring and RAR reception is performed at the serving cell,
dedicated RA resource (e.g. preamble index) can be configured for random access in the candidate cell for early TA acquisition;
dedicated separate search space can be configured for random access in the candidate cell for early TA acquisition;
the RAR can include information of the candidate cell, e.g. cell ID.

In some embodiments, the candidate cell may belong to a timing advance group (TAG). In these embodiments, the terminal device 110 may apply the TA command for the TAG In some embodiments, the terminal device 110 may start or restart a timer for time alignment associated with the TAG In some embodiments, the RA procedure on the candidate cell is contention based RA procedure. If the Contention Resolution is considered as being not successful, the terminal device 110 may stop the timer for time alignment associated with this TAG In these embodiments, if the timer expiries, the terminal device 110 may maintain a TA between downlink and uplink of the TAG In some embodiments, if the timer expires, the terminal device 110 may discard a TA between downlink and uplink of the TAG

In some embodiments, the terminal device 110 may receive a TA Command MAC CE for this TAG from the network device 120, apply the TA Command for the TAG and restart the timer for time alignment associated with the TAG.

In some embodiments, the terminal device 110 may receive, from the network device 120, a MAC CE indicating a cell switch to the candidate cell. Based on the MAC CE, the terminal device 110 may cause the TAG to be a primary timing advance group (PTAG) of the terminal device 110.

For illustration, an example procedure may be described as below:
When a TA command is received in an RAR message for a candidate cell belonging to a TAG (e.g., may be named as candidate TAG (CTAG)):
   for contention-free random access (CFRA), the terminal device 110 may apply the TA command for the TAG, and start or restart a timeAlignmentTimer associated with the TAG; and
   for contention-based random access (CBRA), the terminal device 110 may apply the TA command for the TAG, and start or restart a timeAlignmentTimer associated with the TAG When Contention Resolution is considered as being not successful, the terminal device 110 may stop the timeAlignmentTimer associated with the TAG
When the timeAlignmentTimer associated with the TAG which a candidate cell belongs to expiries, the terminal device 110 may maintain or discard NTA of the TAG, where NTA denotes a TA between DL and UL.
Upon reception of the TA command MAC CE for the TAG, NTA of the TAG may be maintained, and the terminal device 110 may apply the TA command for the TAG, and restart the timeAlignmentTimer.
Upon reception of a MAC CE which triggers LTM to the candidate cell, the TAG becomes a PTAG of the terminal device 110.

In this way, RAR reception may be achieved for a PDCCH ordered RA for TA acquisition of LTM candidate cell.

### Embodiment 2

Currently, for CFRA, a UL grant is included in an RAR, and UE needs to perform further UL transmission although the RA is already successfully completed. However, if an RA procedure for TA acquisition of candidate cell is contention free, after reception of the RAR, performing further UL transmission towards the network is troublesome, specifically towards the candidate cell, since the candidate cell is not a serving cell of the UE yet.

In view of this, embodiments of the present disclosure provide a solution for CFRA to solve the above or other potential issues.

In some embodiments, if the RAR contains a MAC sub-protocol data unit (PDU) with a Random Access Preamble identifier (RAPID) corresponding to the transmitted preamble index, the terminal device 110 may consider that RAR reception is successful.

In some embodiments, the RAR may comprises a MAC sub-PDU and the MAC sub-PDU is a MAC sub-header with a RAPID only. The terminal device 110 may determine that the RA procedure is successfully completed upon reception of the RAR. In other words, a MAC sub-header with RAPID only may be used as a response. In these embodiments, a TA value may be transmitted in a MAC CE which triggers a cell switch.

In some embodiments, the RAR may not comprise uplink grant. The terminal device 110 may determine that the RA procedure is successfully completed upon reception of the RAR. In other words, a new RAR format which does not comprise a UL grant may be used. In some embodiments, the RAR received by the terminal device 110 may comprise a TA value, but does not comprise at least one of a temporary cell radio network temporary identity (T-CRNTI) or a UL grant. Upon reception of this kind of RAR, the terminal device 110 may consider that the RA procedure is successfully completed.

In some embodiments, the terminal device 110 may determine that the RA procedure is successfully completed while ignoring the UL grant in the RAR. In other words, the terminal device 110 may ignore the received UL grant in the RAR, or do not process the received UL grant value and do not indicate it to lower layers (e.g., PHY layer), and may consider that the RA procedure is successfully completed.

In this way, there is no need to perform further UL transmission towards the network especially for the candidate cell.

### Embodiment 3

In case of an RA procedure for TA acquisition of one candidate cell is contention based, the current contention resolution mechanism is no longer suitable. For example, transmitting a cell radio network temporary identity (C-RNTI) MAC CE which includes the C-RNTI of the MAC entity is not valid, because the C-RNTI of the MAC entity is not an identity (ID) of UE in the candidate Cell.

In view of this, embodiments of the present disclosure provide a solution for CBRA to solve the above or other potential issues.

Continue to refer to FIG. 2, if the RAR is successfully received, the terminal device 110 may transmit 250, to the candidate cell of network device 130, a message (e.g., Msg3) comprising an ID of the terminal device 110 using a UL grant scheduled in the RAR. In other words, if the RAR contains a MAC sub-PDU with Random Access Preamble identifier corresponding to the transmitted a preamble index, the terminal device 110 may consider that RAR reception is successful. Then, the terminal device 110 may transmit, in Msg3, an ID of the terminal device 110. In some embodiments, the terminal device 110 may avoid transmitting any other MAC CE and data from any logical channel in Msg3.

In some embodiments, the ID of the terminal device 110 may be a radio network temporary identity (RNTI) of the terminal device 110 associated with the candidate cell. For example, the ID of the terminal device 110 may be a C-RNTI of the terminal device 110 associated with the candidate cell. It is to be understood that the ID of the terminal device 110 may adopt any other suitable forms.

In some embodiments, the RNTI of the terminal device 110 associated with the candidate cell may be configured by the network device 120 by a RRC message, e.g., in a reconfigurationWithSync IE of a cell group configuration associated with the candidate cell.

In some embodiments, the ID of the terminal device 110 may be carried in a MAC CE (for convenience, also referred to as a first MAC CE herein). The first MAC CE may be transmitted in Msg3. In some embodiments, the first MAC CE may be a MAC CE dedicated for early TA acquisition. In some embodiments, the first MAC CE may be a C-RNTI MAC CE.

In some embodiments, a RRC layer of the terminal device 110 may indicate the RNTI of the terminal device 110 associated with the candidate cell to a MAC layer of the terminal device 110.

For illustration, an example procedure may be described as below.
If this is the first successfully received Random Access Response within this Random Access procedure, UE shall
   indicate to the Multiplexing and assembly entity to include a first MAC CE which consists of identity of the UE associated with candidate cell in the subsequent uplink transmission,
   indicate to the Multiplexing and assembly entity to not include other MAC CE or data/MAC SDU from any logical channel in the subsequent uplink transmission, and
   obtain a MAC PDU to transmit from the Multiplexing and assembly entity and store it in a Msg3 buffer.

Continue to refer to FIG. 2, upon transmission of Msg3, the terminal device 110 may start a timer (e.g., ra-ContentionResolutionTimer) for contention resolution, and perform 260 a PDCCH monitoring of the candidate cell while the timer is running.

In some embodiments, the terminal device 110 may monitor a PDCCH transmission of the candidate cell identified by the RNTI of the terminal device 110 associated with candidate cell while the timer for contention resolution is running. The terminal device 110 may receive 270, from the candidate cell of network device 130, a PDCCH transmission addressed to a RNTI of the terminal device 110 associated with the candidate cell, the terminal device 110 then may determine 280 that contention resolution is successful. In some embodiments, the terminal device 110 may stop the timer for contention resolution. In some embodiments, the terminal device 110 may discard a temporary cell radio network temporary identity (T-CRNTI) of the terminal device 110. In some embodiments, the terminal device 110 may determine that the random access procedure is successfully completed.

For example, the terminal device 110 may monitor a PDCCH transmission of the candidate cell identified by the RNTI of the terminal device 110 associated with the candidate cell while the timer is running. If notification of a reception of a PDCCH transmission of the candidate cell is received from lower layers, and if the PDCCH transmission is addressed to the RNTI of the terminal device 110 associated with the candidate cell, the terminal device 110 may perform at least one of the following:
consider this Contention Resolution successful;
stop ra-ContentionResolution Timer;
discard the T-CRNTI; or
consider that this Random Access procedure is successfully completed.

In some alternative embodiments, the terminal device 110 may monitor PDCCH of the candidate cell identified by the T-CRNTI while the timer for contention resolution is running. The terminal device 110 may receive 270′, from the candidate cell of network device 130, a PDCCH transmission addressed to a T-CRNTI of the terminal device 110. If a MAC PDU is successfully decoded, the terminal device 110 may stop the timer for contention resolution. If the MAC PDU comprises a MAC CE (for convenience, also referred to as a second MAC CE herein) matching content in the message (e.g., Msg3), the terminal device 110 may determine 280′ that contention resolution is successful. For example, if the MAC PDU comprises a second MAC CE matching the first MAC CE in Msg3, the terminal device 110 may determine that contention resolution is successful. In some embodiments, the terminal device 110 may discard the T-CRNTI of the terminal device 110, and determine that the RA procedure is successfully completed. In some embodiments, if the MAC CE does not comprise the second MAC CE matching the content in the message, the terminal device 110 may discard the T-CRNTI, and consider that this contention resolution is not successful and discard the successfully decoded MAC PDU.

For example, the terminal device 110 may monitor a PDCCH transmission of the candidate cell identified by the T-CRNTI of the terminal device 110 while the timer for contention resolution is running. If notification of a reception of a PDCCH transmission of the candidate cell is received from lower layers, and if the PDCCH transmission is addressed to the T-CRNTI of the terminal device 110 and the MAC PDU is successfully decoded, the terminal device 110 may stop the timer for contention resolution.
If the MAC PDU contains a second MAC CE, and if the second MAC CE matches the content transmitted in Msg3 (e.g. the first MAC CE), the terminal device 110 may perform at least one of the following:
   consider that this Contention Resolution is successful;
   discard the T-CRNTI; or
   consider that this Random Access procedure is successfully completed.
else (i.e., if the MAC PDU does not contain the second MAC CE, or if the second MAC CE does not match the content transmitted in Msg3 (e.g. the first MAC CE)), the terminal device 110 may perform at least one of the following:
   discard the T-CRNTI; or
   consider that this Contention Resolution is not successful and discard the successfully decoded MAC PDU.

### Embodiment 4

The terminal device 110 monitors for a PDCCH transmission of the candidate cell of network device 130 identified by the RNTI of the terminal device 110 associated with the candidate cell while ra-ResponseWindow is running. In some embodiments, the PDCCH transmission monitoring may be performed on a dedicated search space configured by the network device 130 for contention-free based early TA acquisition. In some embodiments, the terminal device 110 may receive 270″, from the candidate cell of network device 130, a PDCCH transmission addressed to a RNTI of the terminal device 110 associated with the candidate cell. In some embodiments, the terminal device 110 may consider that the RAR is successfully received. In some embodiments, the RNTI of the terminal device 110 associated with the candidate cell may be a C-RNTI of the terminal device 110 associated with the candidate cell.

In some embodiments, if the PDCCH transmission is received, the terminal device 110 may determine 280″ that the RA procedure is successfully completed.

For illustrations, an example procedure may be described as below.
Once the contention free Random Access Preamble is transmitted on the candidate cell, UE starts the ra-ResponseWindow, and monitors for a PDCCH transmission of the candidate cell identified by the RNTI of the terminal device 110 associated with the candidate cell while ra-ResponseWindow is running. The PDCCH transmission monitoring may be performed on a dedicated search space for contention-free early TA acquisition. If the PDCCH transmission is addressed to the RNTI of the terminal device 110 associated with the candidate cell, the terminal device 110 may consider that the Random Access procedure is successfully completed.

With the process 200, RAR reception for PDCCH ordered RA for LTM candidate cell may be defined.

### Example Implementation of Preamble Transmission for Candidate Cell

In case of no RAR for TA acquisition of a candidate cell, there is no explicit indication of whether an RA procedure is successful completed or not. If the RA procedure is not successful, how to perform subsequent RA attempt is unclear, especially how to perform power ramping for the second RA attempt is unclear.

In view of this, embodiments of the present disclosure provide a solution of preamble transmission. This will be described below in connection with FIG. 3.

FIG. 3 illustrates a schematic diagram illustrating another process 300 of communication in an RA procedure for LTM according to embodiments of the present disclosure. For the purpose of discussion, the process 300 will be described with reference to FIG. 1A. The process 300 may involve the terminal device 110 and the network device 120 as illustrated in FIG. 1A. In this example, the network device 120 provides a serving cell (e.g., the cell 121) for the terminal device 110, and the network device 130 provides a candidate cell (e.g., the cell 131) for the terminal device 110. The serving cell may be SPCell, PCell or PSCell of the terminal device 110.

As shown in FIG. 3, the network device 120 may transmit 305, to the terminal device 110, a RRC reconfiguration message comprising a set of RRC configurations corresponding to a set of candidate cells allowing LTM.

The network device 120 may transmit 310, to the terminal device 110, DCI/PDCCH signaling triggering an RA procedure on a candidate cell (e.g., the cell 131) in the set of candidate cells. The DCI/PDCCH signaling comprises a value of a power ramping counter for a preamble (i.e., a value of a preamble power ramping counter).

With reference to FIG. 3, the terminal device 110 may determine 320 received target power for the preamble (i.e., preamble received target power) based on the value of the preamble power ramping counter. It is to be understood that the preamble received target power may be determined in any suitable ways, and the present disclosure does not limit this aspect.

Based on the preamble received target power, the terminal device may transmit 330, to the network device 130, the preamble for the RA procedure.

For illustration, an example procedure may be described as below.
UE receives PDCCH signaling/DCI which triggering the RA on the candidate cell, the value PREAMBLE_POWER_RAMPING_COUNTER of is signaled in PDCCH/DCI. The UE determines the PREAMBLE_RECEIVED_TARGET_POWER for the RA preamble transmission based on the PREAMBLE_POWER_RAMPING_COUNTER value received from PDCCH/DCI.

With the process 300, a preamble transmission for PDCCH ordered RA for LTM candidate cell may be properly achieved without RAR.

### Example Implementation of Preamble Transmission for Candidate Cell

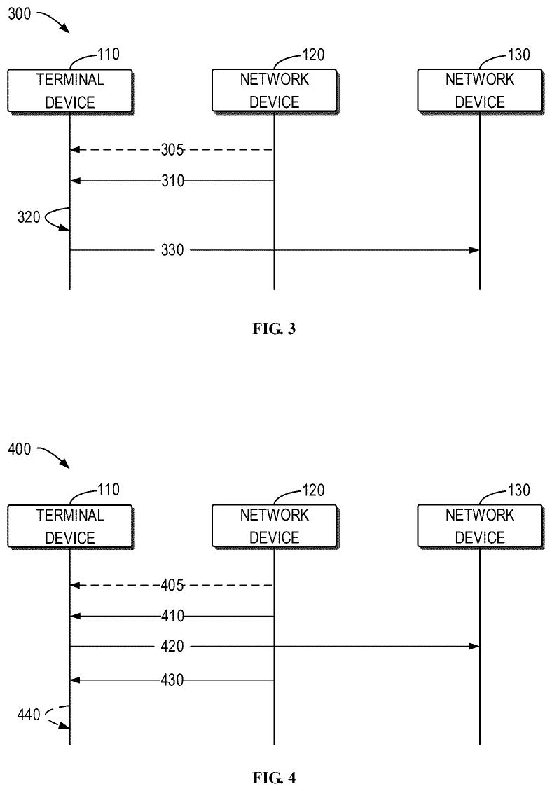

Embodiments of the present disclosure provide a solution of an RA procedure without RAR. This will be described below in connection with FIG. 4.

FIG. 4 illustrates a schematic diagram illustrating still another process 400 of communication in an RA procedure for LTM according to embodiments of the present disclosure. For the purpose of discussion, the process 400 will be described with reference to FIG. 1A. The process 400 may involve the terminal device 110 and the network device 120 as illustrated in FIG. 1A. In this example, the network device 120 provides a serving cell (e.g., the cell 121) for the terminal device 110, and the network device 130 provides a candidate cell (e.g., the cell 131) for the terminal device 110. The serving cell may be SPCell, PCell or PSCell of the terminal device 110.

As shown in FIG. 4, the network device 120 may transmit 405, to the terminal device 110, a RRC reconfiguration message comprising a set of RRC configurations corresponding to a set of candidate cells allowing LTM.

The serving cell of network device 120 may transmit 410, to the terminal device 110, DCI (for convenience, also referred to as first DCI herein) triggering an RA procedure on a candidate cell (e.g., the cell 131) in the set of candidate cells.

With reference to FIG. 4, the terminal device 110 may transmit 420, to the candidate cell in the network device 130, a preamble for the RA procedure.

The terminal device 110 may receive 430, from the network device 120, DCI (for convenience, also referred to as second DCI herein) indicating whether the RA procedure is successfully completed.

In some embodiments, upon reception of the first DCI, the terminal device 110 may start a timer, and perform, while the timer is running, monitor the PDCCH of the serving cell of the network device 120 for the second DCI. For example, UE receives PDCCH signaling/DCI which triggering the RA on the candidate cell, sets the preamble power ramping counter as 1 during a random Access procedure initialization, performs preamble transmission, starts a timer and monitors the PDCCH of the SpCell for Random Access Response(s) identified by the RA-RNTI while the timer is running. In some embodiments, the timer may be an RAR window (e.g., ra-ResponseWindow). It is to be understood that any other suitable ways are also feasible. In some embodiments, upon reception of the second DCI, the terminal device 110 may stop the timer.

In some embodiments, if the timer expiries, the terminal device 110 may determine that the RA procedure is successfully completed. In some alternative embodiments, if the timer expiries, the terminal device 110 may determine the RA procedure is unsuccessfully completed.

Continue to refer to FIG. 4, in some embodiments, if the RA procedure is unsuccessfully completed, the terminal device 110 may perform 440 an RA resource selection procedure during which a power ramping counter for a preamble is increased.

For example, if the second PDCCH signaling/DCI indicates that the RA procedure is unsuccessful completed, UE performs the Random Access Resource selection procedure, and during which the preamble power ramping counter is increased by 1. If the second PDCCH signaling/DCI indicates that the RA procedure is successfully completed, the terminal device 110 may determine that the RA procedure is successfully completed.

With the process 400, an RA procedure may be defined for PDCCH ordered RA for LTM candidate cell.

### Example Implementation of Methods

Accordingly, embodiments of the present disclosure provide methods of communication implemented at a terminal device. These methods will be described below with reference to FIGS. 5 to 7.

FIG. 5 illustrates an example method 500 of communication implemented at a terminal device in accordance with some embodiments of the present disclosure. For example, the method 500 may be performed at the terminal device 110 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the terminal device 110 receives, from a serving cell (e.g., the cell 121), DCI triggering an RA procedure on a candidate cell (e.g., the cell 131) in a set of candidate cells allowing LTM.

At block 520, the terminal device 110 transmits, to the candidate cell, a preamble for the RA procedure. At block 530, the terminal device 110 performs a PDCCH monitoring on at least one of the serving cell or the candidate cell.

At block 540, the terminal device 110 receives an RAR from the at least one of the serving cell or the candidate cell. In some embodiments, the RAR may comprise a TA command for the candidate cell.

In some embodiments where the terminal device 110 receives the RAR from the serving cell, the terminal device 110 may transmit the preamble on an RA resource dedicated for the candidate cell. Alternatively or additionally, the terminal device 110 may perform the PDCCH monitoring based on a search space dedicated for the candidate cell. In some embodiments, the RAR may comprise information of the candidate cell.

In some embodiments where the candidate cell belongs to a TAG, the terminal device 110 may apply the TA command for the TAG In some embodiments, the terminal device 110 may start or restart a timer for time alignment associated with the TAG. If the timer expiries, the terminal device 110 may maintain a TA value of the TAG In some embodiments, the terminal device 110 may receive, from the serving cell, a MAC CE indicating a cell switch to the candidate cell, and cause the TAG to be a PTAG of the terminal device 110.

In some embodiments, if the RAR comprises a MAC sub-PDU and the MAC sub-PDU is a MAC sub-header with an RAPID only, the terminal device 110 may determine that the RA procedure is successfully completed. In some embodiments, if the RAR does not comprise uplink grant, the terminal device 110 may determine that the RA procedure is successfully completed. In some embodiments, if the RAR comprises the uplink grant, the terminal device 110 may determine that the RA procedure is successfully completed while ignoring the uplink grant.

In some embodiments, if the RAR is successfully received, the terminal device 110 may transmit a message comprising an ID of the terminal device 110 to the candidate cell using an uplink grant scheduled in the RAR. In some embodiments, the ID of the terminal device 110 may be a RNTI of the terminal device 110 associated with the candidate cell. In some embodiments, the ID of the terminal device 110 may be carried in a first MAC CE.

In some embodiments, the terminal device 110 may start a timer for contention resolution, and perform a PDCCH monitoring of the candidate cell while the timer is running. In some embodiments, the terminal device 110 may receive, from the candidate cell, a PDCCH transmission addressed to a RNTI of the terminal device 110 associated with the candidate cell, and determine that contention resolution is successful. In some embodiments, the terminal device 110 may stop the timer for contention resolution, discard a T-CRNTI of the terminal device 110, and determine that the RA procedure is successfully completed.

In some embodiments, the terminal device 110 may receive, from the candidate cell, a PDCCH transmission addressed to a T-CRNTI of the terminal device 110. If a MAC PDU is successfully decoded, the terminal device 110 may stop the timer for contention resolution. If the MAC PDU comprises a second MAC CE matching contents in the message, the terminal device 110 may determine that contention resolution is successful. In some embodiments, the terminal device 110 may discard the T-CRNTI of the terminal device 110, and determine that the RA procedure is successfully completed.

In some embodiments, the terminal device 110 may receive, from the candidate cell, a PDCCH transmission addressed to a RNTI of the terminal device 110 associated with the candidate cell. In this case, the terminal device 110 may determine that the RAR is received. In some embodiments, if the PDCCH transmission is received, the terminal device 110 may determine that the RA procedure is successfully completed.

With the method 500, an RA procedure may be achieved for a candidate cell of LTM.

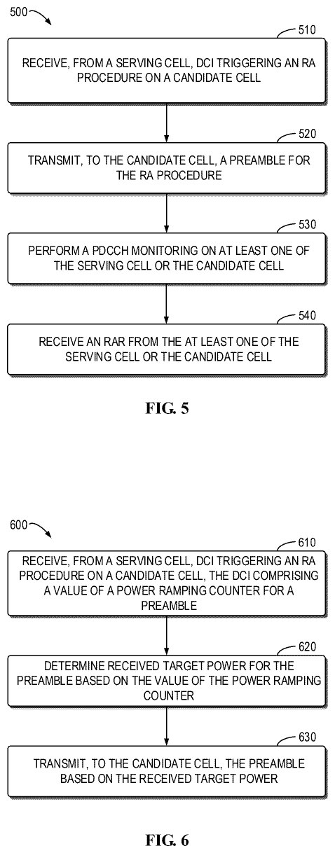

FIG. 6 illustrates another example method 600 of communication implemented at a terminal device in accordance with some embodiments of the present disclosure. For example, the method 600 may be performed at the terminal device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the terminal device 110 receives, from a serving cell (e.g., the cell 121), DCI triggering an RA procedure on a candidate cell (e.g., the cell 131) in a set of candidate cells allowing LTM. The DCI comprises a value of a power ramping counter for a preamble.

At block 620, the terminal device 110 determines received target power for the preamble based on the value of the power ramping counter.

At block 630, the terminal device 110 transmits, to the candidate cell, the preamble for the RA procedure based on the received target power.

With the method 600, a preamble transmission to a candidate cell for LTM may be achieved without RAR.

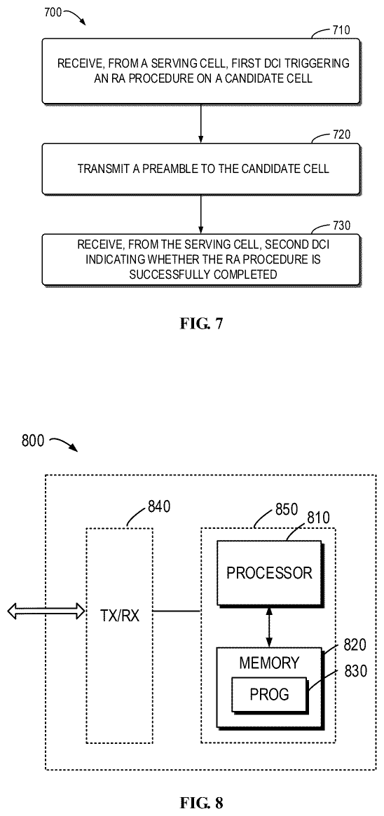

FIG. 7 illustrates still another example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 may receive, from a serving cell (e.g., the cell 121), first DCI triggering an RA procedure on a candidate cell (e.g., the cell 131) in a set of candidate cells allowing LTM.

At block 720, the terminal device 110 may transmit, to the candidate cell, a preamble for the RA procedure.

At block 730, the terminal device 110 may receive, from the serving cell, second DCI indicating whether the RA procedure is successfully completed.

In some embodiments, if the first DCI is received, the terminal device 110 may start a timer, and perform, while the timer is running, a monitoring for the second DCI. In some embodiments, if the timer expiries, the terminal device 110 may determine that the RA procedure is successfully completed. In some embodiments, if the timer expiries, the terminal device 110 may determine the RA procedure is unsuccessfully completed.

In some embodiments, if the RA procedure is unsuccessfully completed, the terminal device 110 may perform an RA resource selection procedure during which a power ramping counter for a preamble is increased.

With the process 700, an RA procedure may be achieved for a candidate cell for LTM.

It is to be understood that the operations of methods 500 to 700 are similar as that described in connection with FIGS. 2 to 4, and thus other details are not repeated here for concise.

### Example Implementation of Devices and Apparatuses

FIG. 8 is a simplified block diagram of a device 800 that is suitable for implementing embodiments of the present disclosure. The device 800 can be considered as a further example implementation of the terminal device 110 or the network device 120 as shown in FIG. 1A, or the CU 141, the DU 151 or the DU 152 as shown in FIG. 1D. Accordingly, the device 800 can be implemented at or as at least a part of the terminal device 110 or the network device 120 or the CU 141 or the DU 151 or 152.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1A to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: receive, from a serving cell, downlink control information triggering a random access procedure on a candidate cell in a set of candidate cells allowing layer 1 or layer 2 triggered mobility; transmit, to the candidate cell, a preamble for the random access procedure; perform a physical downlink control channel monitoring on at least one of the serving cell or the candidate cell; and receive a random access response from the at least one of the serving cell or the candidate cell.

In some embodiments, a terminal device comprises a circuitry configured to: receive, from a serving cell, downlink control information triggering a random access procedure on a candidate cell in a set of candidate cells allowing layer 1 or layer 2 triggered mobility, the downlink control information comprising a value of a power ramping counter for a preamble; determine received target power for the preamble based on the value of the power ramping counter; and transmit, to the candidate cell, the preamble for the random access procedure based on the received target power.

In some embodiments, a terminal device comprises a circuitry configured to: receive, from a serving cell, first downlink control information triggering a random access procedure on a candidate cell in a set of candidate cells allowing layer 1 or layer 2 triggered mobility; transmit, to the candidate cell, a preamble for the random access procedure; and receive, from the serving cell, second downlink control information indicating whether the random access procedure is successfully completed.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a terminal device comprises a processor configured to cause the terminal device to: receive, from a serving cell, downlink control information triggering a random access procedure on a candidate cell in a set of candidate cells allowing layer 1 or layer 2 triggered mobility; transmit, to the candidate cell, a preamble for the random access procedure; perform a physical downlink control channel monitoring on at least one of the serving cell or the candidate cell; and receive a random access response from the at least one of the serving cell or the candidate cell.

In some embodiments, the random access response comprises a timing advance command for the candidate cell.

In some embodiments, the terminal device is caused to receive the random access response from the serving cell, and the terminal device is caused to at least one of the following: transmit the preamble on a random access resource dedicated for the candidate cell; or perform the physical downlink control channel monitoring based on a search space dedicated for the candidate cell. In some embodiments, the random access response comprises information of the candidate cell.

In some embodiments, the candidate cell belongs to a timing advance group, and the terminal device is further caused to at least one of the following: apply the timing advance command for the timing advance group; start or restart a timer for time alignment associated with the timing advance group; or in accordance with a determination that the timer expiries, maintain a timing advance of the timing advance group.

In some embodiments, the terminal device is further caused to: receive, from the serving cell, a medium access control control element indicating a cell switch to the candidate cell; and cause the timing advance group to be a primary timing advance group of the terminal device.

In some embodiments, the terminal device is further caused to: in accordance with a determination that the random access response comprises a medium access control sub-protocol data unit and the medium access control sub-protocol data unit is a medium access control sub-header with a random access preamble identity only, determine that the random access procedure is successfully completed; or in accordance with a determination that the random access response does not comprise uplink grant, determine that the random access procedure is successfully completed; or in accordance with a determination that the random access response comprises the uplink grant, determine that the random access procedure is successfully completed while ignoring the uplink grant.

In some embodiments, the terminal device is further caused to: in accordance with a determination that the random access response is successfully received, transmit a message comprising an identity of the terminal device to the candidate cell using an uplink grant scheduled in the random access response.

In some embodiments, the identity of the terminal device is a radio network temporary identity of the terminal device associated with the candidate cell.

In some embodiments, the identity of the terminal device is carried in a first medium access control control element.

In some embodiments, the terminal device is further caused to: start a timer for contention resolution; and perform a physical downlink control channel monitoring of the candidate cell while the timer is running.

In some embodiments, the terminal device is further caused to: receive, from the candidate cell, a physical downlink control channel transmission addressed to a radio network temporary identity of the terminal device associated with the candidate cell; and determine that contention resolution is successful.

In some embodiments, the terminal device is further caused to: stop the timer for contention resolution; discard a temporary cell radio network temporary identity of the terminal device; and determine that the random access procedure is successfully completed.

In some embodiments, the terminal device is further caused to: receive, from the candidate cell, a physical downlink control channel transmission addressed to a temporary cell radio network temporary identity of the terminal device; in accordance with a determination that a medium access control protocol data unit is successfully decoded, stop the timer for contention resolution; and in accordance with a determination that the medium access control protocol data unit comprises a second medium access control control element matching contents in the message, determine that contention resolution is successful.

In some embodiments, the terminal device is further caused to: discard the temporary cell radio network temporary identity of the terminal device; and determine that the random access procedure is successfully completed.

In some embodiments, the terminal device is caused to receive the random access response by: receiving, from the candidate cell, a physical downlink control channel transmission addressed to a radio network temporary identity of the terminal device associated with the candidate cell. In some embodiments, the terminal device is further caused to: in accordance with a determination that the physical downlink control channel transmission is received, determine that the random access procedure is successfully completed.

In another solution, a terminal device comprises a processor configured to cause the terminal device to: receive, from a serving cell, downlink control information triggering a random access procedure on a candidate cell in a set of candidate cells allowing layer 1 or layer 2 triggered mobility, the downlink control information comprising a value of a power ramping counter for a preamble; determine received target power for the preamble based on the value of the power ramping counter; and transmit, to the candidate cell, the preamble for the random access procedure based on the received target power.

In another solution, a terminal device comprises a processor configured to cause the terminal device to: receive, from a serving cell, first downlink control information triggering a random access procedure on a candidate cell in a set of candidate cells allowing layer 1 or layer 2 triggered mobility; transmit, to the candidate cell, a preamble for the random access procedure; and receive, from the serving cell, second downlink control information indicating whether the random access procedure is successfully completed.

In some embodiments, the terminal device is caused to receive the second downlink control information by: in accordance with a determination that the first downlink control information is received, starting a timer; and performing, while the timer is running, a monitoring for the second downlink control information.

In some embodiments, the terminal device is further caused to: in accordance with a determination that the timer expiries, determine that the random access procedure is successfully completed; or in accordance with a determination that the timer expiries, determine that the random access procedure is unsuccessfully completed.

In some embodiments, the terminal device is further caused to: in accordance with a determination that the random access procedure is unsuccessfully completed, perform a random access resource selection procedure during which a power ramping counter for a preamble is increased.

In another solution, a method of communication comprises: receiving, at a terminal device and from a serving cell, downlink control information triggering a random access procedure on a candidate cell in a set of candidate cells allowing layer 1 or layer 2 triggered mobility; transmitting, to the candidate cell, a preamble for the random access procedure; performing a physical downlink control channel monitoring on at least one of the serving cell or the candidate cell; and receiving a random access response from the at least one of the serving cell or the candidate cell.

In another solution, a method of communication comprises: receiving, at a terminal device and from a serving cell, downlink control information triggering a random access procedure on a candidate cell in a set of candidate cells allowing layer 1 or layer 2 triggered mobility, the downlink control information comprising a value of a power ramping counter for a preamble; determining received target power for the preamble based on the value of the power ramping counter; and transmitting, to the candidate cell, the preamble for the random access procedure based on the received target power.

In another solution, a method of communication comprises: receiving, at a terminal device and from a serving cell, first downlink control information triggering a random access procedure on a candidate cell in a set of candidate cells allowing layer 1 or layer 2 triggered mobility; transmitting, to the candidate cell, a preamble for the random access procedure; and receiving, from the serving cell, second downlink control information indicating whether the random access procedure is successfully completed.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE), the method comprising:
receiving, from a first Radio Access Network (RAN) node of a serving cell, a first Physical Downlink Control Channel (PDCCH) order that initiates a Random Access (RA) procedure for a candidate cell configured for L1/L2 Triggered Mobility (LTM candidate cell);
setting a preamble power ramping counter to 1;
performing random access preamble transmission to a second RAN node of the LTM candidate cell;
receiving, from the first RAN node, a second PDCCH order that initiates the RA procedure for the LTM candidate cell, the second PDCCH order including information that causes random access preamble re-transmission; and
incrementing the preamble power ramping counter by 1.

22. The method according to claim 21, the method further comprising:
determining, using the preamble power ramping counter, a preamble received target power; and
performing, using the preamble received target power, random access preamble transmission to the second RAN node of the LTM candidate cell.

23. The method according to claim 22, wherein the first RAN node is a next generation Node B (gNB) and the second RAN node is a gNB.

24. A User Equipment (UE) comprising:
at least one processor; and
at least one memory coupled to the at least one processor, the at least one memory storing instructions that when executed by the at least one processor cause the at least one processor to:
receive, from a first Radio Access Network (RAN) node of a serving cell, a first Physical Downlink Control Channel (PDCCH) order that initiates a Random Access (RA) procedure for a candidate cell configured for L1/L2 Triggered Mobility (LTM candidate cell);
set a preamble power ramping counter to 1;
perform random access preamble transmission to a second RAN node of the LTM candidate cell;
receive, from the first RAN node, a second PDCCH order that initiates the RA procedure for the LTM candidate cell, the second PDCCH order including information that causes random access preamble re-transmission; and
increment the preamble power ramping counter by 1.

25. The UE according to claim 24, wherein the instructions when executed by the at least one processor, further cause the at least one processor to:
determine, using the preamble power ramping counter, a preamble received target power; and
perform, using the preamble received target power, random access preamble transmission to the second RAN node of the LTM candidate cell.

26. The UE according to claim 25, wherein the first RAN node is a next generation Node B (gNB) and the second RAN node is a gNB.
